(19) United States
(12) Patent Application Publication
(10) Pub. No.: US 2025/0084753 A1
(43) Pub. Date: Mar. 13, 2025

(54) METHODS FOR IN-SITU QUANTIFICATION OF CEMENT-TO-CASING OR FORMATION-TO-CASING INTERFACIAL ACOUSTIC BOND AND RELATION TO HYDRAULIC PROPERTIES OF SUCH INTERFACE

(71) Applicant: Schlumberger Technology Corporation, Sugar Land, TX (US)

(72) Inventors: Smaine Zeroug, Lexington, MA (US); Sandip Bose, Brookline, MA (US)

(21) Appl. No.: 18/580,214

(22) PCT Filed: Jul. 20, 2022
(86) PCT No.: PCT/US2022/037664

§ 371 Date: Jan. 18, 2024

Related U.S. Application Data
(60) Provisional application No. 63/223,998, filed on Jul. 21, 2021.

(51) Int. Cl. E21B 47/005; G01V 1/48

(52) U.S. Cl. CPC E21B 47/005; G01V 1/48; E21B 2200/20; G01V 2210/6222

(57) ABSTRACT

Embodiments presented provide for a method for in situ quantification of bonding between a wellbore casing and the surrounding media. Quantification may be established through acoustical sampling of the interface to determine appropriate relationships between the casing and the surrounding media.

### CROSS-REFERENCE TO RELATED APPLICATIONS

The present application claims priority to U.S. Provisional Application 63/223,998 dated Jul. 21, 2021, the entirety of which is incorporated by reference.

### FIELD OF THE DISCLOSURE

Aspects of the disclosure relate to performing characterization of field values in hydrocarbon recovery operations. More specifically, aspects of the disclosure relate to characterizing an interfacial bond between a wellbore casing and annular fill.

### BACKGROUND

Well integrity in the oil and gas industry is critical to ensure environmentally-safe exploitation of subsurface hydrocarbons resources. This has become critical with the recent advent of tougher and more restrictive governmental regulations. Cements or cement-like materials are often used to fill the annular space between steel casing and rock formation and provide a seal that prevents fluid channeling from reservoir intervals to upper strata via the annular space. Conventional operations strive to provide a sealing capability that is, at a minimum, similar to the seal naturally offered by reservoir cap layers before the well was drilled. Operators in certain oil and gas fields in the world elect not to cement certain intervals. These operators rely on creeping rock formations to fill the annular space and provide the required seal. The seal efficiency is related to the strength of the mechanical bond that is established at the interface between sealing material (cement, cement-like, or a creeping formation) and steel casing. The tighter the sealing material bonds to the casing the higher the likelihood to offer a satisfactory sealing efficiency against fluid channeling at the interface.

Whether a tight interfacial bond is established at the onset of the well completion and whether it is maintained over time depends on several factors that include well downhole conditions, formation properties, as well a production processes-factors whose effects on the bond are not readily predictable and may change during the course of the well production lifetime. Hence, the necessity to evaluate this bond at the onset of the well completion, during its production lifetime as well as at its abandonment phase. Acoustic measurements have been widely used for this need. They include well-established low-frequency approaches such as the CBL or cement bond log and the higher-frequency pulse-echo and pitch-catch or flexural type of measurements.

Acoustic measurements are based on dynamic small-strain mechanical vibrations that probe the casing, the annular fill and, for low-frequency methods, the rock formation. The mechanical vibrations generated by the acoustic measurements are affected by the contrast they encounter at the interface between steel and the annular material. The degree of the effects depends on the direction of propagation and polarization of the vibrations at the interface. These effects become embedded in the characteristics of the signals that are sensed by the measurement device receivers. Such characteristics relate to the amplitude and phase of the signals over their associated wide temporal frequency bands.

The level of the acoustic strains induced in the steel and annular fill as well as at the interface is extremely small—of the order of 10\hat{ }{−8} to 10\hat{ }{−9} offering a non-invasive means to evaluate the interfacial bond. The interfacial bond seen by the acoustic vibrations can be parametrized by two compliance components: normal, hN, and tangential, hT, to the interface plane. These quantities relate the vibration-associated traction at the interface to a discontinuity in the normal and tangential components of the particle displacement field, respectively.

A need exists for the ultrasonic or high-frequency measurements that provide azimuthal resolution of the annular fill properties and, implement both pulse-echo and pitch-catch modalities that provide sensitivities to hN and hT as well as the intrinsic properties of the annular fill. These sensitivities are documented in this memo through example data and inversions.

The inversion for the parameters themselves rely on various attributes of the signals acquired and may be conducted sequentially or simultaneously on the multi-modality signals depending on the conditions of the case under study. Various known inversion techniques can be used to this effect.

Once the interfacial compliances and annular fill intrinsic properties are estimated, separately from each other, an interpretation of the hydraulic properties such as permeability and sealing efficiency, of the interface between annular fill and casing, can be established.

There is a need to provide a characterization of the bond between an outside surface of a wellbore casing and the surrounding material.

There is a further need to provide characterization methods that do not have the drawbacks of incomplete or inaccurate analysis and potential leakage, as discussed above.

There is a still further need to reduce economic costs associated with wellbore operations by allowing operations personnel to accurately predict bonding between an outside surface of a wellbore casing and the material surrounding the wellbore casing.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for in-situ quantification of a bond between a casing and an annular fill is described. The method comprises sending ultrasonic signals to a desired location of a wellbore casing wherein the bond is to be determined. The method further comprises receiving reflected ultrasonic signals from the desired location. The method further comprises inverting the received reflected ultrasonic signals and processing the inverted received ultrasonic signals to produce at least one physical parameter of an annual fill at the interface location.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 shows an example workflow for data collection from ultrasonic pitch-catch measurements and their inversion to yield parameters VP, Vs, hN, and hT of the annular fill and its interfacial bond to casing, as a function of depth and azimuth.

FIG. 2 is a sketch of an example experimental set-up for controlled laboratory experiments combining fluid flow and pressure measurements with in situ ultrasonic measurements, to generate related datasets between the two sets of measurements. For this purpose, the estimated ultrasonic bond suitably aggregated in the patch between each pair of access ports is here used to predict the measured permeability between those two ports. This process can be repeated for each pair to generate the labelled data for training the deep network. according to an embodiment of the disclosure.

FIG. 3 is a generic workflow for collecting training data to train a deep network and use for inference purposes on downhole acquired ultrasonic data to predict interfacial hydraulic properties.

FIG. 4 depicts a cemented casing with a PVC tube confining a neat cement sheath. The 6 mm-thick casing is scanned from within it with a rotating pulse-echo measurement to generate data covering all depth and azimuth. The cement sheath is isolated from the water in the test tank within which the experiment takes place.

FIG. 5 depicts an inversions result for the apparent acoustic impedance, AIapp, as a function of azimuth and axial distance, after 3 hours of curing indicating the AI level reached is between 3 and 4 MRayl, a level well below the expected final AI when the cement cures.

FIG. 6 depicts an inverted images of apparent AI (Alapp) (left) and normal interfacial compliance, hN, (right) after 23 hours from the time the cement was poured into the annulus. At this time, the cement sheath is considered as having cured and bonded well to the casing. Consequently, the inverted apparent AI is assigned largely to the intrinsic AI of the cement while the inverted hN shows mostly a well-welded condition with hN being zero, except in a small region where hN is assigned the reduction in AIapp. For subsequent inversion at later times, the intrinsic Al of the cement is assumed to remain constant while any variations in Alapp is assigned to variations in hN.

FIG. 7 illustrates the same types of data as FIG. 6 but at 28 hours after cementation. The changes from AIapp in FIG. 3 are totally assigned to variations in the bond strength via hN which is seen to increase from a zero level. hN is expressed in mm/GPa.

FIG. 8 illustrates the same types of data as FIG. 6 but at 47 hours after cementation. The significant decrease in Alapp is believed to be due to a debonding of the cement from the casing surface and thus assigned to an increase in the interfacial compliance hN as shown to the right (to be contrasted to the same image in FIG. 7.)

FIG. 9 illustrates the same types of data as FIG. 6 but at 196 hours after cementation. The debonding of the cement from the casing increases and is totally assigned the interfacial compliance, hN.

FIG. 10 illustrates the same types of data as FIG. 6 but at 228 hours after cementation

FIG. 11 illustrates the same types of data as FIG. 6 but at 334 hours after cementation. The cement sheath is nearly all detached from the casing-especially the lower part. Accordingly, the interfacial compliance, hN, increases to larger levels.

FIG. 12 illustrates the plane-wave reflection coefficient, amplitude and phase for a casing-cement interface as a function of the interfacial compliance, hN, for an acoustically-fast cement (top) and acoustically-slow cement (bottom).

FIG. 13 illustrates attenuation dispersions for the casing extensional mode (SO) for various casing-cement bonding conditions parametrized with the compliance normal and tangential components, hN and hT, respectively. A zero value for the compliance refers to a non-compliant interface—indicating continuity in the wave-associated particle displacement along the direction considered. An acoustically-fast cement with VP=3500m/s and Vs=2000 m/s and a casing with 3/8″ (9.525 mm) thickness are considered. Note the discontinuity at 0.3 MHz related to VP of the cement intersecting the SO wavespeed dispersion at this frequency.

FIG. 14 illustrates the same types of data as in FIG. 13 but for the flexural mode (AO).

FIG. 15 illustrates the same types of data as in FIG. 13 for the extensional mode (SO), but for an acoustically moderate cement with VP=2700m/s and Vs=1400 m/s.

FIG. 16 illustrates the same types of data as in FIG. 14 but for the flexural mode (AO). Note the discontinuity around 0.16 MHz related to VP of the cement intersecting the AO wavespeed dispersion at this frequency.

FIG. 17 illustrates plots of attenuation dispersions (in colored dots) estimated from simulated signals and from a mode search solver (in continuous lines), for various casing-cement bonding conditions. The latter are parametrized with the compliance normal and tangential components, hN and hT, respectively. The simulated signals are generated using a time-domain numerical solver for the pitch-catch measurement. These plots pertain to an acoustically-moderate cement with VP=2700m/s and Vs=1400 m/s. The mode search solver considers the eigen-value problem in a steel plate-like configuration—the curves show here are generated using a scheme that compensates for the additional attenuation associated with beam divergence along the propagation direction parallel to the casing.

FIG. 18 Same as in FIG. 17 but for data pertaining to an acoustically-fast cement with VP=3500 m/s and Vs=2000 m/s.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Disclosed herein is a method for the characterization of the interfacial bond between casing and annular fill assumed to be solid using non-invasive ultrasonic measurements performed at a specific time. In one or more embodiments, the measurements are performed at multiple times—and these are referred to as acquisition in time-lapse mode. In one or more embodiments, the interpretation of such ultrasonic characterizations in terms of hydraulic properties such as permeability and sealing efficiency, of the interface between annular fill.

In one or more embodiments ultrasonic pulse-echo and pitch-catch data can be used.

In one or more embodiments single acquisitions with both modalities can be used. For example, in one or more embodiments a method to process and interpret acoustic data from ultrasonic pulse-echo and pitch-catch measurements in terms of intrinsic acoustic properties of the solid annular fill and interfacial bond between said annular fill and steel casing. The interfacial bond is expressed in terms of a normal, hN, and tangential, hT, interfacial compliance components or an acoustically-equivalent thin liquid-filled layer of specific thickness and acoustic properties. Such ultrasonic pulse-echo and pitch-catch measurements to be based on logging type devices known in the art that are equipped with ultrasonic transmitting and receiving transducers aligned at normal or oblique incidence with respect to the casing surface and energized by signals in the frequency range of 50 kHz to 800 KHz. Such transmitting transducers can be multiple in configuration and incorporate receiving transducers to form arrays to provide data suitable for array processing methods; such devices to offer azimuthal resolution by either mechanically rotating while scanning the casing or be implemented on multiple azimuthal sectors to provide the desired resolution. The processing method to process first the pitch-catch data followed by processing of the pulse-echo data or process both datasets simultaneously. The processing of the pitch-catch data can in part use the teaching of

U.S. Pat. No. 9,534,487, entitled: “Cement acoustic properties from ultrasonic signal amplitude dispersions in cased wells”; U.S. Pat. No. 9,784,875, entitled: “Method to estimate cement acoustic wave speeds from data acquired by a cased hole ultrasonic cement evaluation tool”; and U.S. Pat. No. 9,732,607, entitled: “Methods and apparatus for evaluating properties of cement utilizing ultrasonic signal testing,” the entirety of the foregoing US Patents are incorporated herein in their entirety. The method can also include in the following method steps:
1.1.1. Such processing of the pitch-catch data to invert for acoustic properties of the annular fill. Such properties to be comprised of the following parameters: speeds of compressional and/or shear waves, referred to as wave speeds, V_{P} and Vₛ, respectively, that can propagate in said annular fill; density of such annular fill (r), and interfacial compliances (h_{N} and h_{T}). Depending on the condition of the annular fill, casing, and quality of the data, these parameters may or may not be inverted for separately. When they are not, the additional pulse-echo measurement is also employed to disambiguate the combined effects of the parameters in question.
1.1.2. The processing in 1.1.1 may rely on discontinuities in the attenuation dispersions when these are present, as per the teaching of U.S. Pat. No. 9,784,875, or rely on nondispersive waves when these are detected, as per the teaching of US Patent No: 9,732,607. In such a case, the method is known to invert for wave speeds V_{P} and Vₛ or V_{P} only or Vₛ only. For purposes of description these parameters are ascribed to be intrinsic to the annular fill;
1.1.3. The processing in 1.1.1 may also enable the estimation of the interfacial compliance components h_{N} and/or h_{T} in addition to the intrinsic wave speeds;
1.1.4. The processing in 1.1.1 may not enable the estimation of the interfacial compliance components h_{N}and/or h_{T} in which case additional data from the pulse-echo acquisition are used to invert for these parameters separately as detailed below;
1.2. Such processing method to process second the pulse-echo data with the aim to estimate separately h_{N} and then h_{T};
   1.2.1. Such processing of the pulse-echo data to estimate an acoustic impedance (AI) of the annular fill which we ascribe to be an apparent AIₐₚₚ as comprised of the effects of both the intrinsic AI of the annular fill, known to be the product of the annular fill V_{P} by r, and the normal interfacial bond parameterized by h_{N};
   1.2.2. Such processing to invert for h_{N} from the apparent AIₐₚₚ using V_{P} in case this is known from a previous step as in 1.1.1 or 1.1.2;
   1.2.3. Such processing to convert h_{N} into an acoustically-equivalent liquid layer of specific thickness h and bulk acoustic properties K and m known as the layer Lame constants;
1.3. Such processing method to invert for h_{N} and h_{T} from AIₐₚₚ of step 1.2.1 and combined set of parameters estimated in steps 1.1.1-1.1.3; known methods of multi-parameters inversions can be used to this effect;
1.4. Alternatively to processing the pitch-catch and pulse-echo data separately and in sequence, the processing method may also perform the inversion simultaneously on both datasets to invert for all parameters of interest: V_{P}, Vₛ, h_{N}, and h_{T}; known methods of multi-parameters inversions can be used to this effect;
1.5. Such processing method to generate an image or logs of the inverted parameters V_{P}, Vₛ, h_{N}, and h_{T} of the annular fill as a function of depth and azimuth.

In one or more embodiments, multiple acquisitions with both modalities mode with both modalities can be used, this can be referred to as—time-lapse. For example, a method to process and interpret time-lapse acoustic data from ultrasonic pulse-echo and pitch-catch measurements in terms of intrinsic acoustic properties of the solid annular fill and interfacial bond between said annular fill and steel casing and their time evolution. Said method to process each dataset resulting in inverted sets of VP, Vs, hN and hT.

Said interpretation method of the inverted parameters is to depend on the specific time phases encompassing the time-lapse acquisitions and on the opinions of subject matter experts as to any observed changes during the time-lapse period to be associated with the bulk of the annular fill or essentially limited to the strength of its bond with the casing. In case of a cemented annulus, the annular fill evaluation is of interest during the primary cementation job where the cement cures and its mechanical properties as well as bond strength are expected to increase with time in the first 24 to 48 hours after the cement slurry is placed. In such a case, the inverted VP and/or Vs parameters are interpreted as a function of time to determine whether the cement has reached its expected strength as for instance measured on the surface prior to cementing the well. Cement compressive strength, a quantity often used in the industry, can be derived by correlation with VP. Deviations from expected behavior may be interpreted as deficiencies that need to be remedied. In case of a cemented annulus, another phase may occur over a longer timeframe during the production life of the well where the casing and cement sheath are subjected to variations in pressure production cycling and thermal stresses from reservoir fluid flow within the casing resulting possibly more in variations on the bond strength and less of the intrinsic properties of the cement. Decreases in bond strength for instance may lead to allowance of undesirable fluid flow across subsurface strata. The variations in the inverted compliances hN and hT may be interpreted in terms of loss of sealing efficiency. In case of a formation layer creep against the casing, it is expected that variations in inverted parameters relate essentially to the strength of the bond to the casing. Such variations in the inverted compliances hN and hT may be interpreted in terms of loss of sealing efficiency. Such processing method to generate, for each acquisition dataset, an image or logs of the inverted parameters VP, Vs, hN, and hT of the annular fill as a function of depth and azimuth.

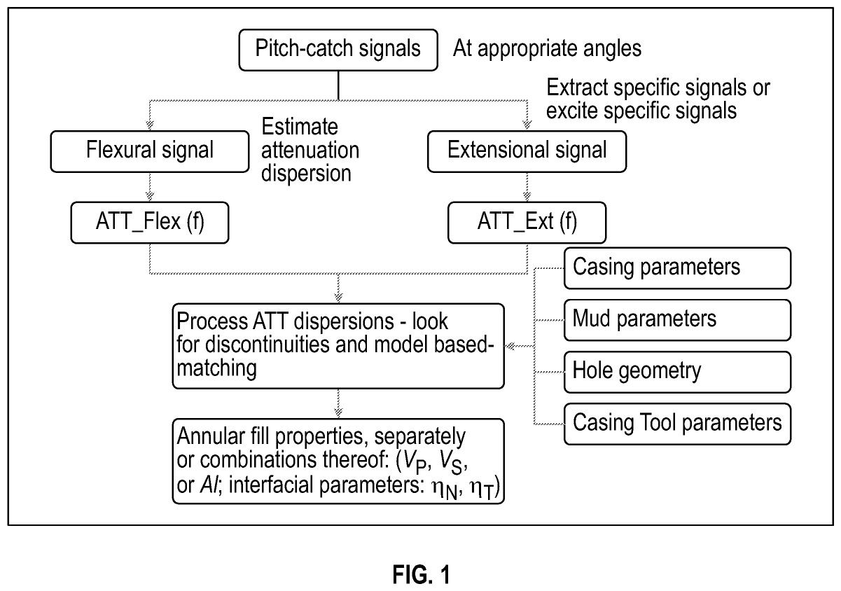

FIG. 1 shows an example workflow for data collection from ultrasonic pitch-catch measurements and their inversion to yield parameters VP, Vs, hN, and hT of the annular fill and its interfacial bond to casing, as a function of depth and azimuth. Examples of workflows employing the pulse-echo measurement data solely or both modalities can be depicted similarly to the one shown in FIG. 1.

In one or more embodiments, interpretation of acoustic estimates in terms of hydraulic properties such as interfacial permeability and sealing efficiency. There is interest in relating ultrasonic parameters to hydraulic properties of the interface in question and that is because the ultrasonic measurements are non-invasive and can be conducted downhole whereas the dynamic measurements cannot be performed downhole in a non-invasive way, besides being costly to conduct. The latter type are arguably the more pertinent ones as they inform on the sealing capacity of the annular fill. In this sense, the ultrasonic parameters can be thought of as a proxy for the dynamic measurements. The challenge is that there are no known relationships that relate the static ultrasonic estimates to the dynamic pressure estimates. Relationships or correlations are found that may be present between the two sets of data. It is preferable that these data be acquired simultaneously using controlled experiments conducted in a laboratory setting on cemented samples covering the parametric operational envelope of interest. To derive these correlations, advanced deep learning techniques are used to build non-linear regressions between the two sets of data and use the developed neural network in inference mode to interpret ultrasonic estimates in terms of hydraulic estimates. As such, data acquired downhole with ultrasonic tools can then be interpreted in terms of hydraulic properties that would inform the decision taking on the sealing capacity of the annular fill. Laboratory experiments that can be employed include the cement simulator reported in a simulator or laboratory experiments where lab-scale casings are cemented within a pressure vessel that allows on the one hand to conduct fluid flow and pressure through the interface, of controllable thickness, between casing and cement and on the other hand capable of taking ultrasonic measurements from within the casing.

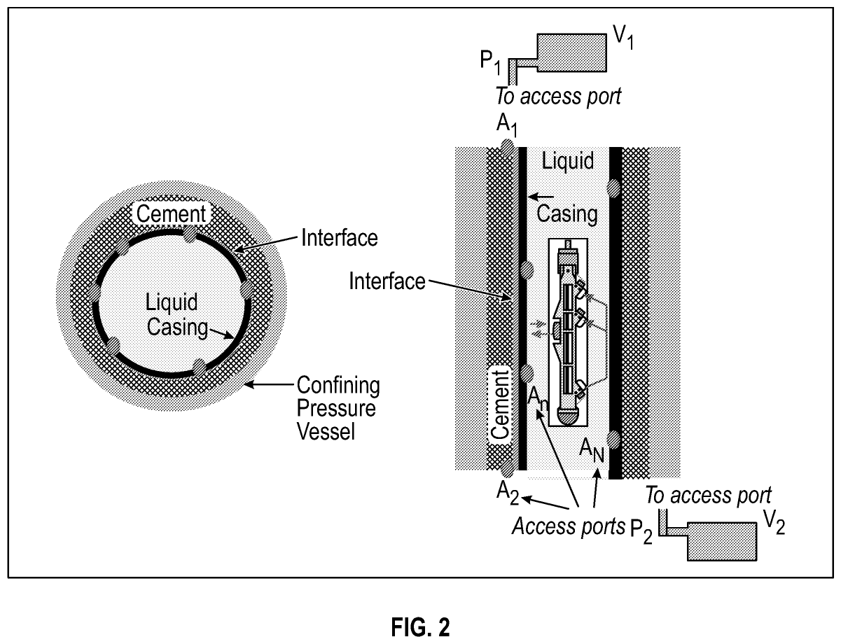

FIG. 2 depicts a sketch of an example experimental set-up up to be conducted under controlled conditions within a pressure vessel and where the evaluation ultrasonic device is immersed in liquid (water for instance) to allow for acoustic coupling to the casing. The set-up considers the provision of a series of access ports both at the ends of the cement sheath and also disposed axially and azimuthally around the casing to take local measurements of interface permeability. This enables both to generate a larger dataset as well as better match variations in the acoustic bond as measured by the ultrasonic tool. A method and an apparatus to generate datasets with fluid flow and pressure measurements simultaneously with ultrasonic pulse-echo and pitch-catch measurements; to process such datasets with known or newly devised nonlinear regression methods; for the purpose of interpreting single-instances and time-lapse ultrasonic pulse-echo and pitch-catch measurements data acquired downhole in terms of hydraulic properties of the interface between annular fill and casing, comprised, but not limited to, interfacial permeability and sealing efficiency.

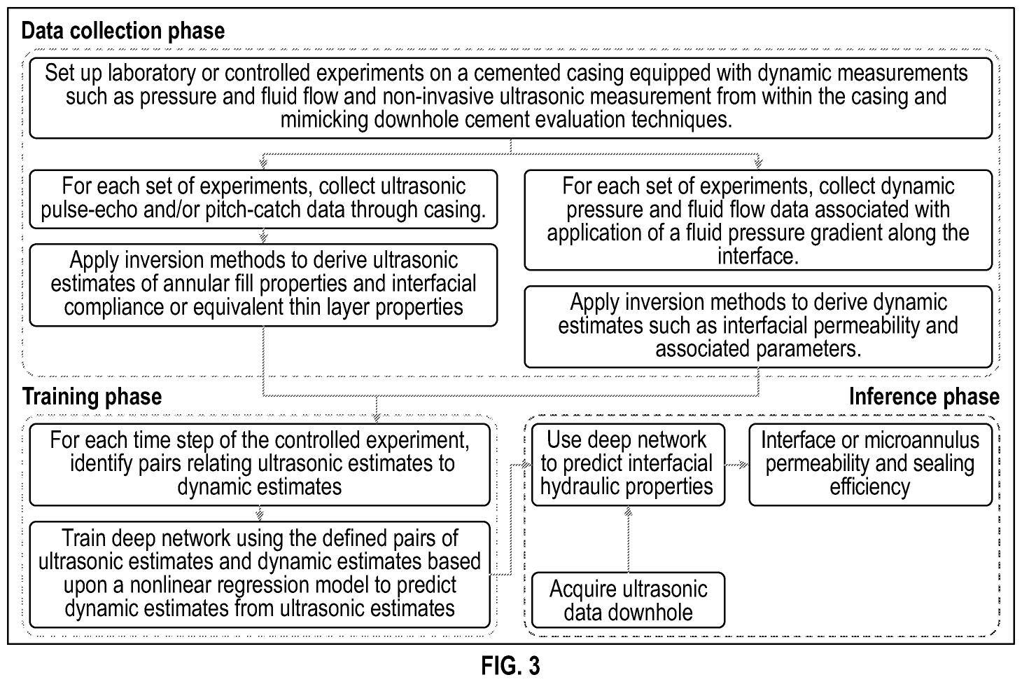

An embodiment of the processing method workflow and apparatus that can be implemented and practiced are captured in the generic workflow is shown in FIG. 3. Such a workflow is used for data collection, deep learning training, and inference on ultrasonic downhole data to predict interfacial hydraulic properties. In the sections below, we describe results to illustrate part of the processing workflows for the pulse-echo and pitch-catch measurement data inversion.

### Inversion of Time-Lapse Pulse-Echo Data

In this section, inversion results are shown for the normal compliance, hN, using time-lapse pulse-echo data. The inversion of the annular fill acoustic impedance (AI) is based on known techniques. This inverted AI is referred to as apparent (or effective) and denote it by AIapp so as to recognize both the annular fill intrinsic AI and interfacial condition affect the signal and thus the inverted Al. Many published studies have interpreted a decrease in inverted AI as due to the likely existence of a microannulus that diminishes the interfacial bond between casing and annular fill.

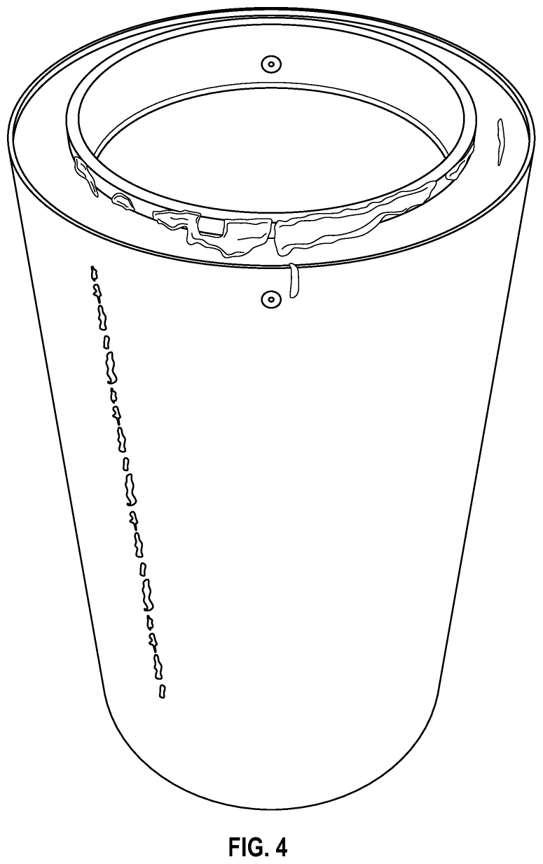

In this section, interfacial bonds are quantified for pulse-echo data that has been acquired in a laboratory setting under controlled conditions. A representative casing of 6 mm thickness was cemented with Neat cement to a PVC pipe as shown in FIG. 4 The 6 mm-thick casing is placed in a water tank and scanned from within it with a rotating with an ultrasonic pulse-echo system to generate signals covering all depths (every 2 cm across a height of 25 cm) and azimuths (every 5 degrees). The cemented sheath is isolated from the water by the PVC pipe. Further, the PVC pipe is specifically used for this test to offer a compliant boundary for the cement sheath allowing it to actually disbond from the casing as time evolves.

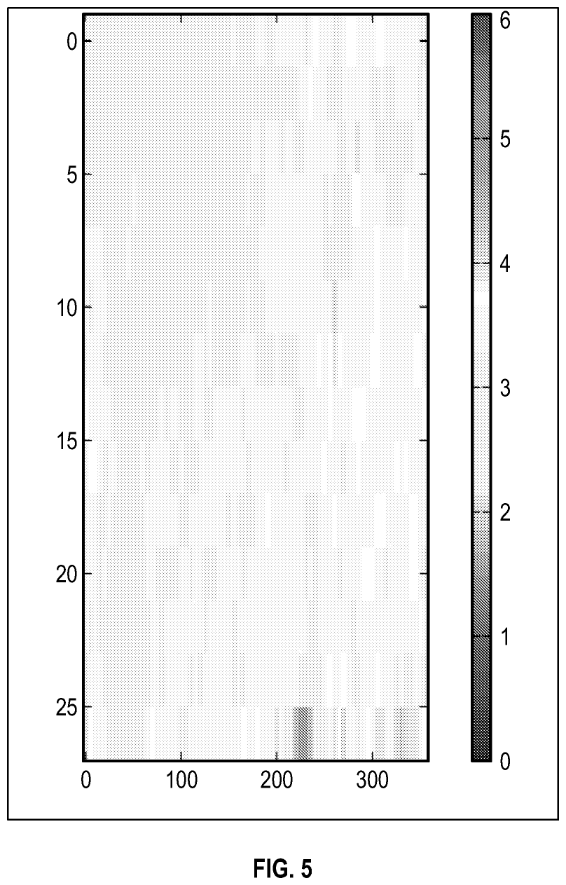

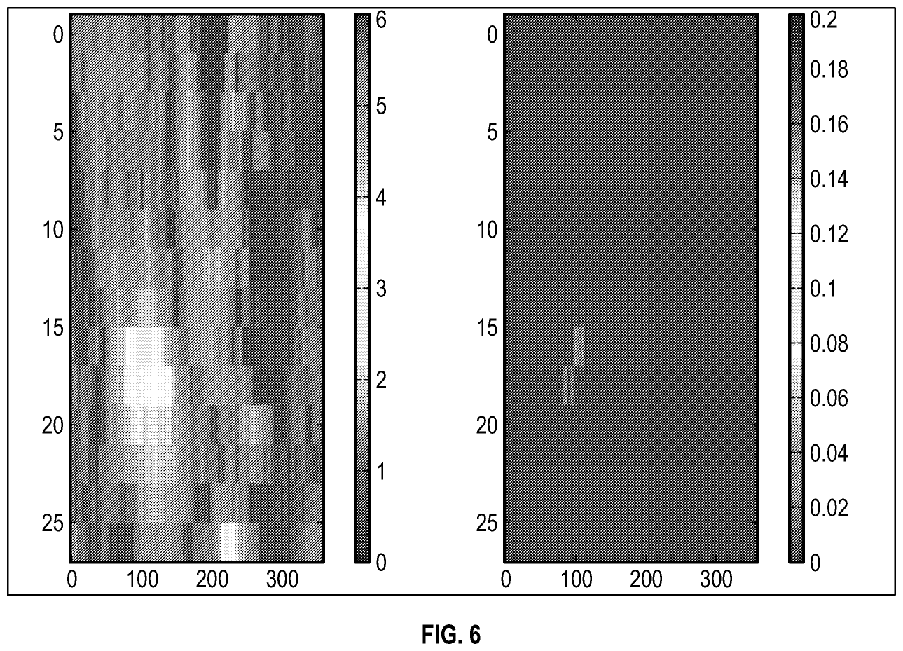

FIGS. 5 to 11 present results of the estimated intrinsic Al of the cement and quantify the variation of the casing-to-cement bond via hN. We assume that the cement cures after about 23 hours and bonds well to the casing. The inverted Alapp is assigned largely to the intrinsic Al of the cement while hN is assigned a value at zero or close to zero to indicate a well bonded cement to the casing. This is presented in FIG. 6. Note that FIG. 5 shows the inverted Alapp for a much earlier acquisition at 3 hours after the cement was poured into the sample.

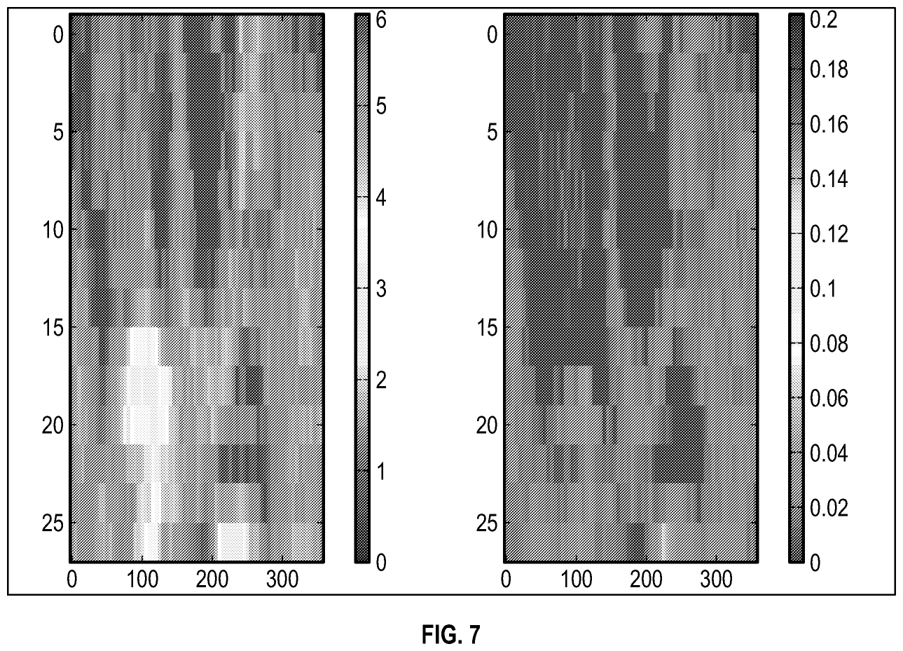

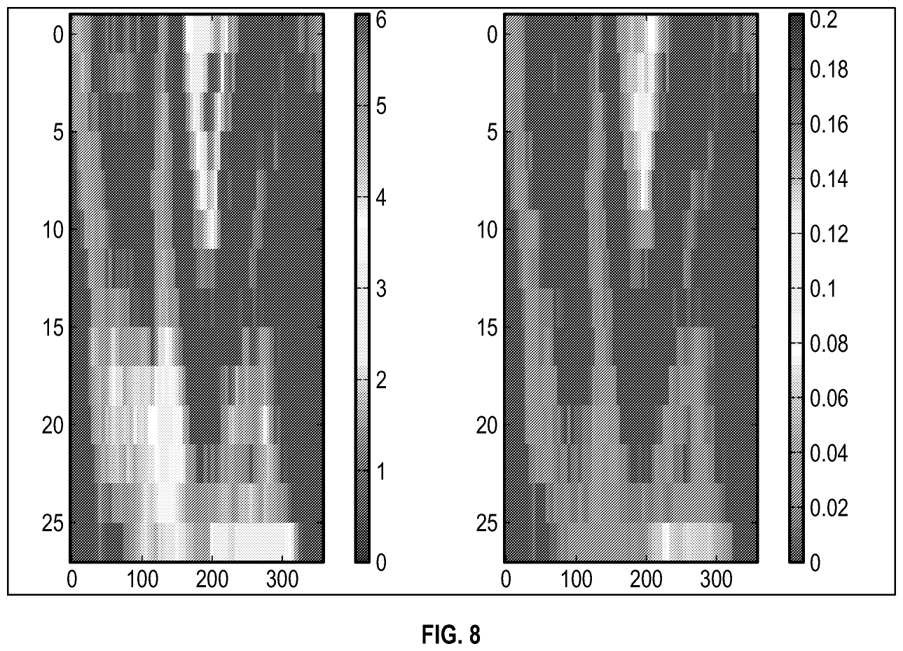

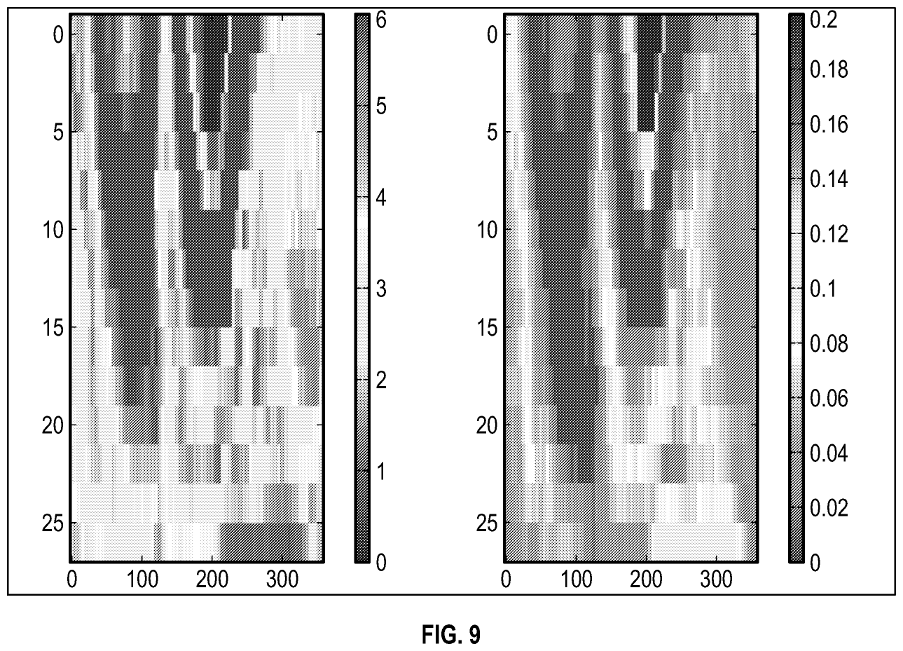

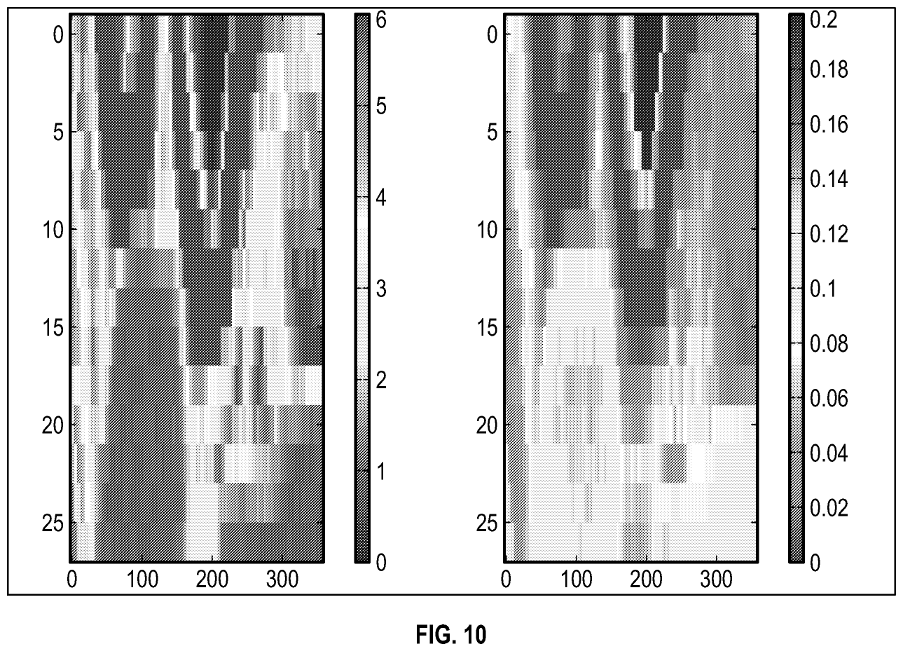

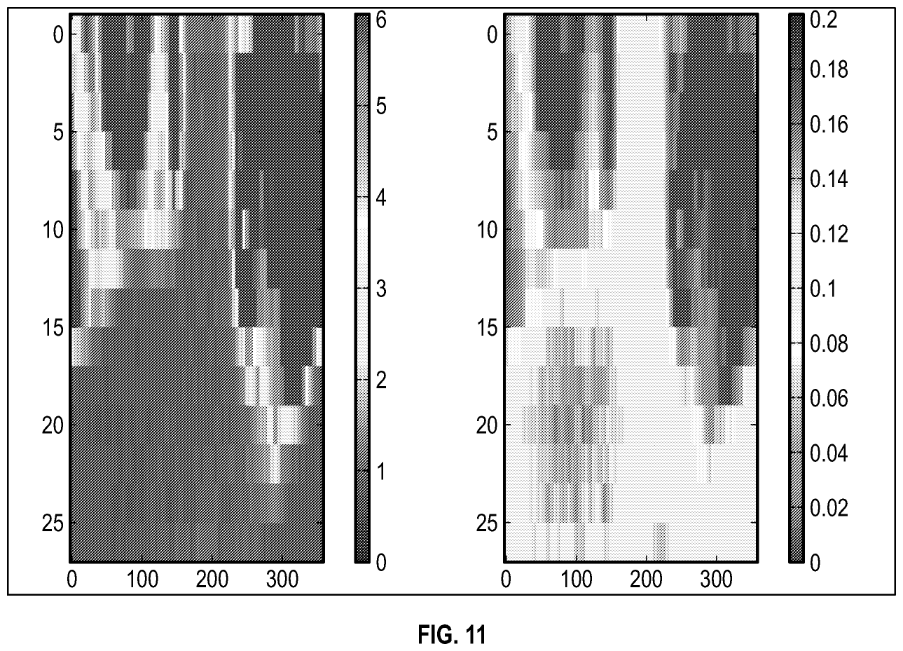

Acquisitions made beyond the reference time of 23 hours are considered for changes in the inverted Alapp and these changes assigned to variations in hN. Several examples are shown in FIG. 7 at 28 hours, FIG. 8 at 47 hours, FIG. 9 at 196 hours, FIG. 10 at 228 hours, and lastly FIG. 11 at 334 hours. They show Alapp and the corresponding inverted hN image under the assumption the intrinsic Al of the cement remains essentially the same as in FIG. 6.

### Interpretation in Terms of a Thin Layer

The model employed for the AI inversion of the pulse-echo signal whether approximate as in the plane-wave transmission-line model or rigorous makes use of the plane-wave reflection coefficient Rpp at the casing-cement interface. This quantity can be expressed in terms of the acoustic impedance (equal to the product: Vp×density) of the casing and that of the annular fill as well as the interfacial compliance, hN.

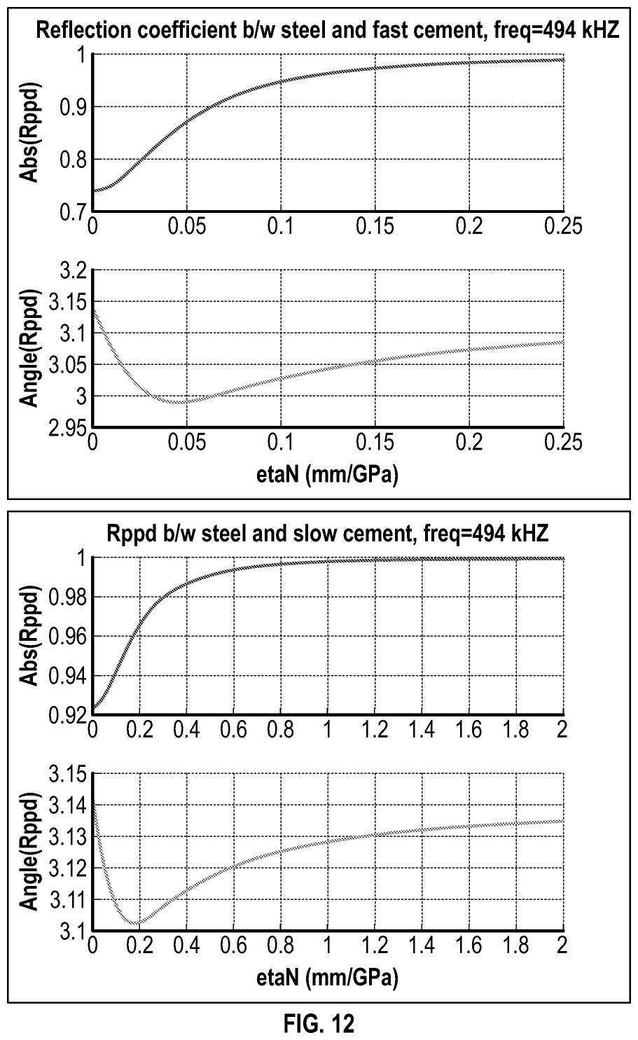

FIG. 12 shows the variation of Rpp, amplitude and phase, as a function of hN for an acoustically-fast cement and an acoustically-moderate cement.

A thin layer of specific properties can be considered in-lieu of the interface. Two approaches can be shown to yield essentially a similar variation in Rpp when the following relationship between hN and the thin layer properties is satisfied (hL is used here to denote hN):

$${η}_{L} = \frac{h}{( {K}^{′} + \frac{4}{3} {μ}^{′} )}$$

Where h, K′, and m′ are, respectively the thickness of the thin layer and its bulk Lame constants. Assuming the layer to be filled with water of compressibility K′ (known to be equal to 2.25 GPa and thickness 2.25 mm (shear modulus m′ for water is nil), then the equivalent hN is found to be equal to 1.

Considering the image of the estimated hN in FIG. 9 for data acquired 196 hours after cementation; we observe that hN is equal on average about 0.1 mm/GPa. The equivalent water layer that would offer similar effects on the inverted Alapp from the acquired signal, would be of thickness 0.225 mm (0.1 mm/GPa×2.25 GPa).

### Sensitivity of Flexural and Extensional Lamb Modes to the Interfacial Compliances

The sensitivity of the attenuation dispersions of the flexural and extensional Lamb modes to both the intrinsic properties of the annular fill as well as to the interfacial compliances, hN and hT are shown below.

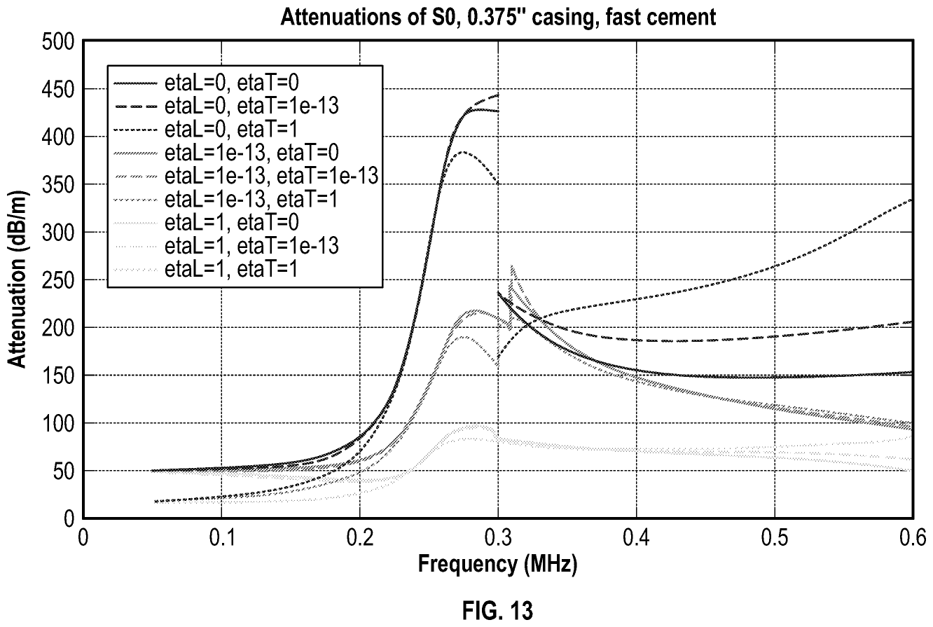

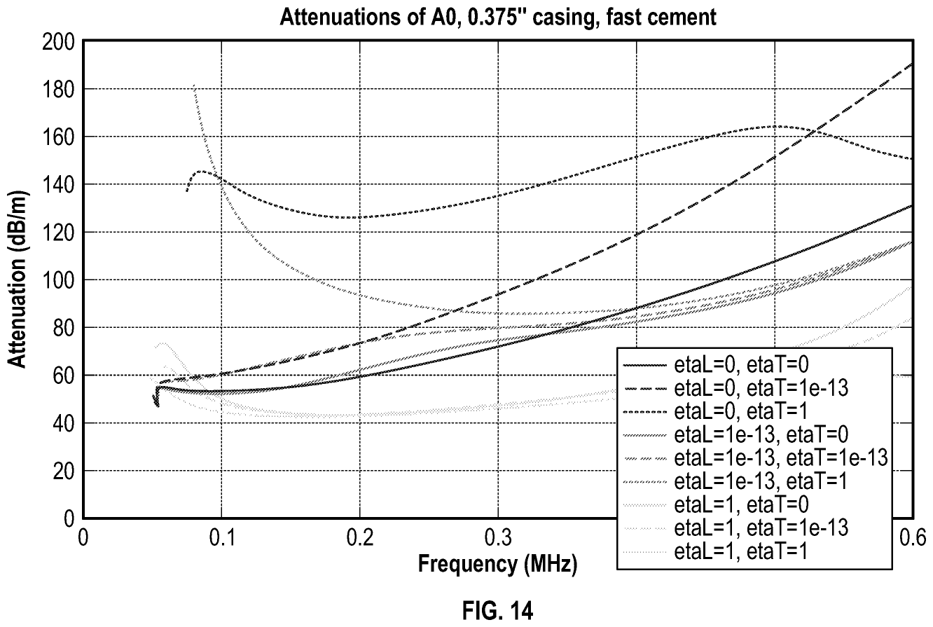

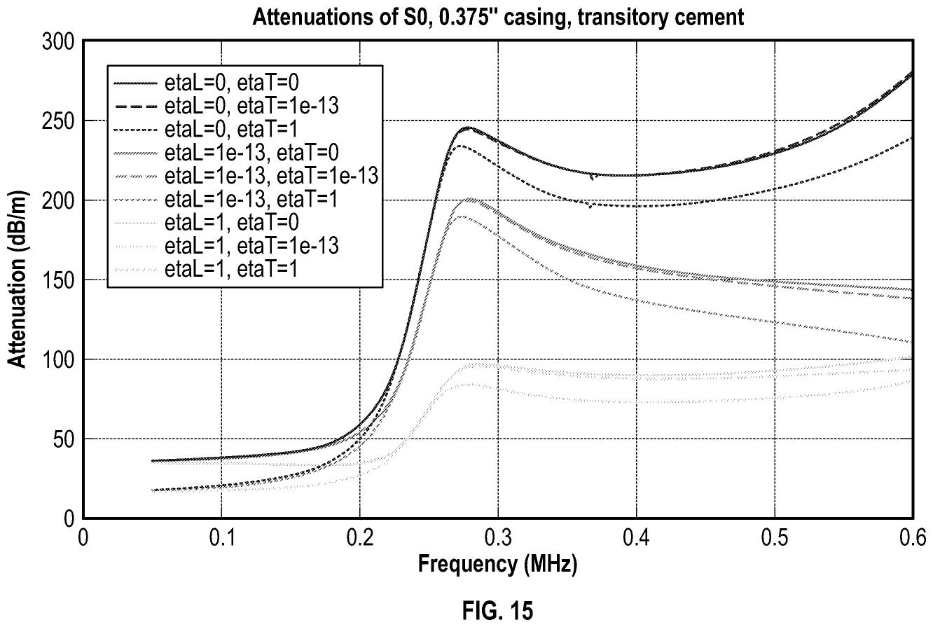

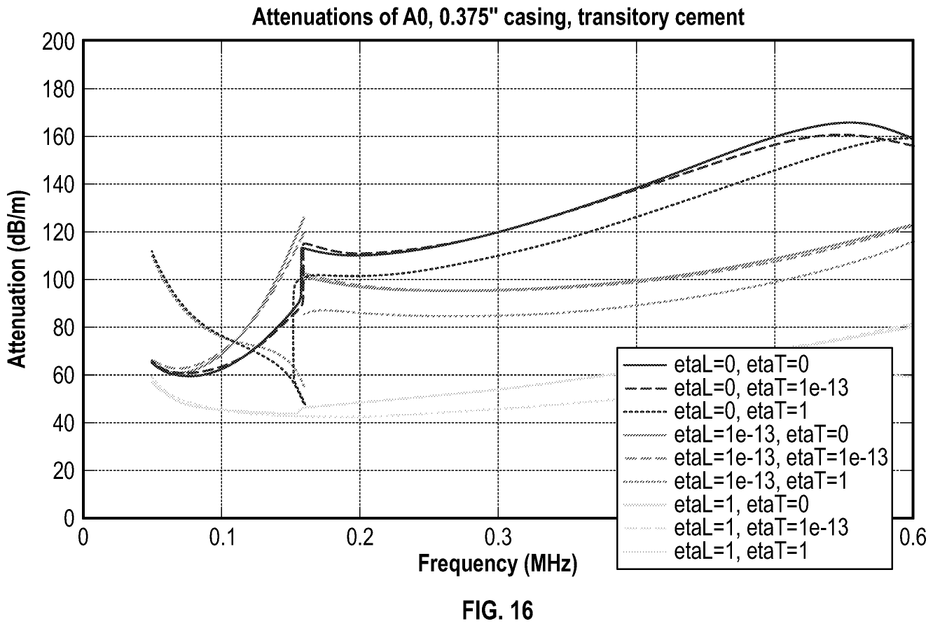

FIGS. 13 to 16 show the corresponding attenuation dispersions for various values of hN and hT for two types of cements: acoustically-fast cement in FIGS. 13 and 14, and an acoustically-moderate cement in FIGS. 15 and 16. Note the discontinuities in the dispersion correspond to the intersection of the cement Vp with either the extensional mode wavespeed dispersion (for an acoustically-fast cement) or the flexural mode wavespeed dispersion (for an acoustically-moderate cement). These discontinuities in well-resolved attenuation dispersions directly reveal the values of the cement wavespeed.

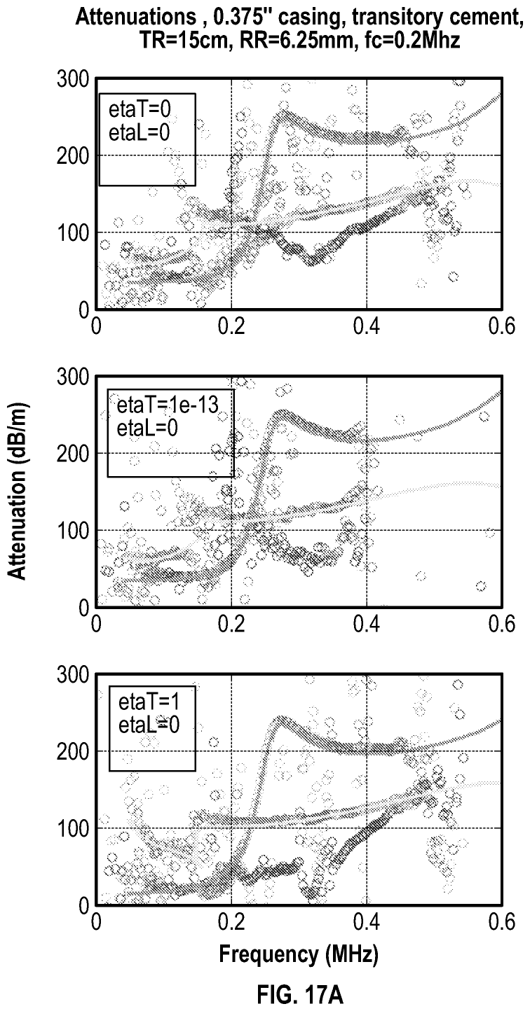

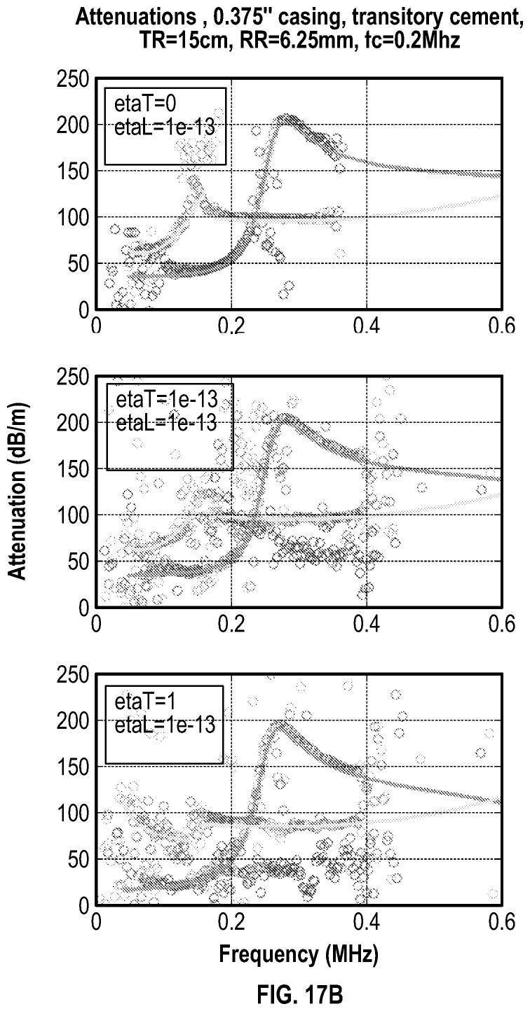

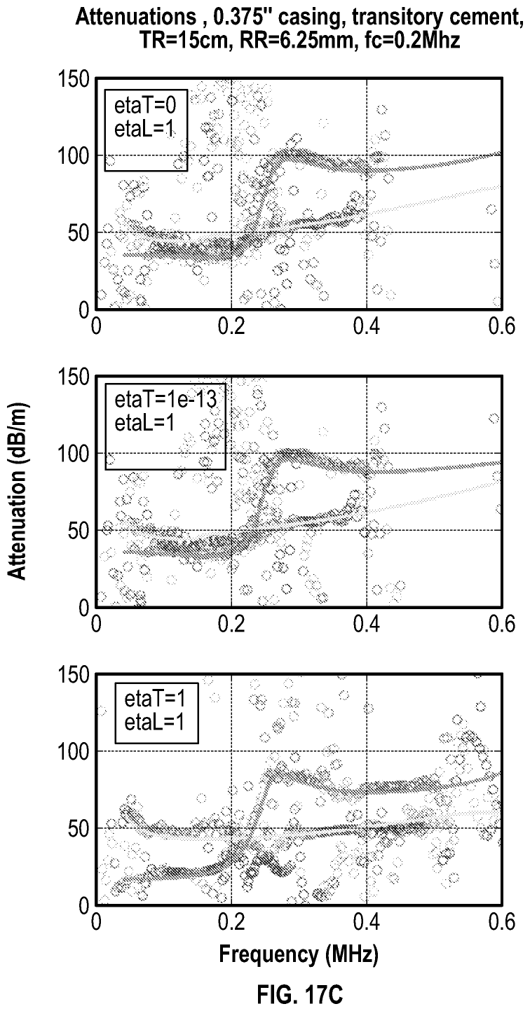

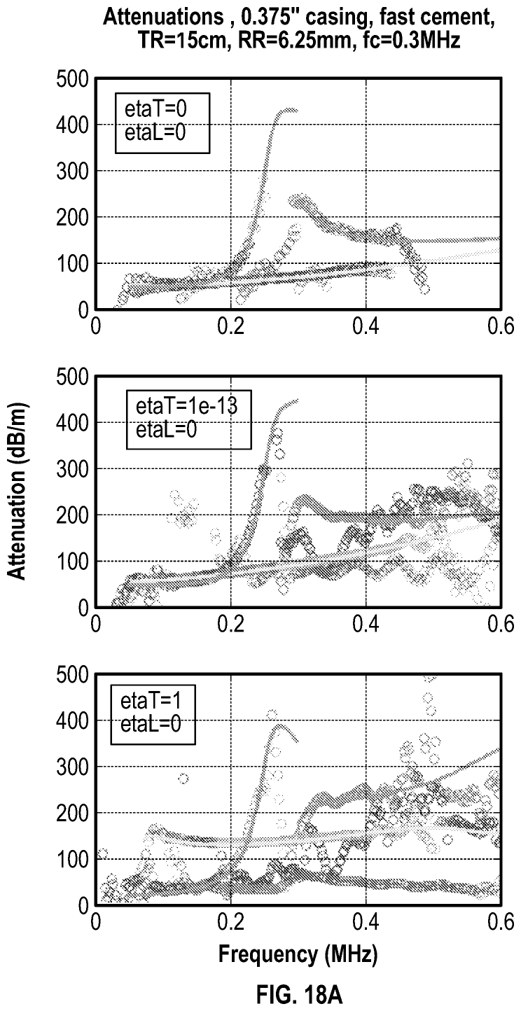

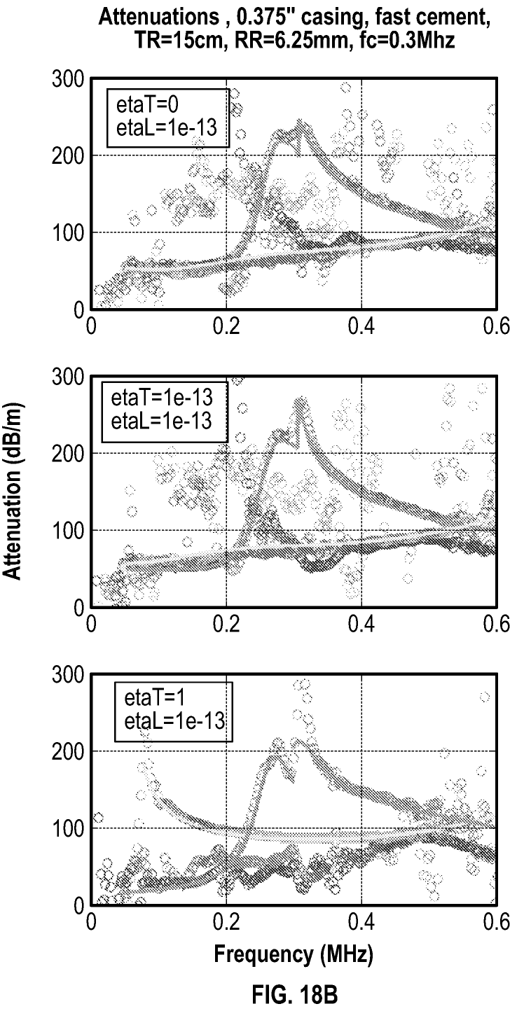

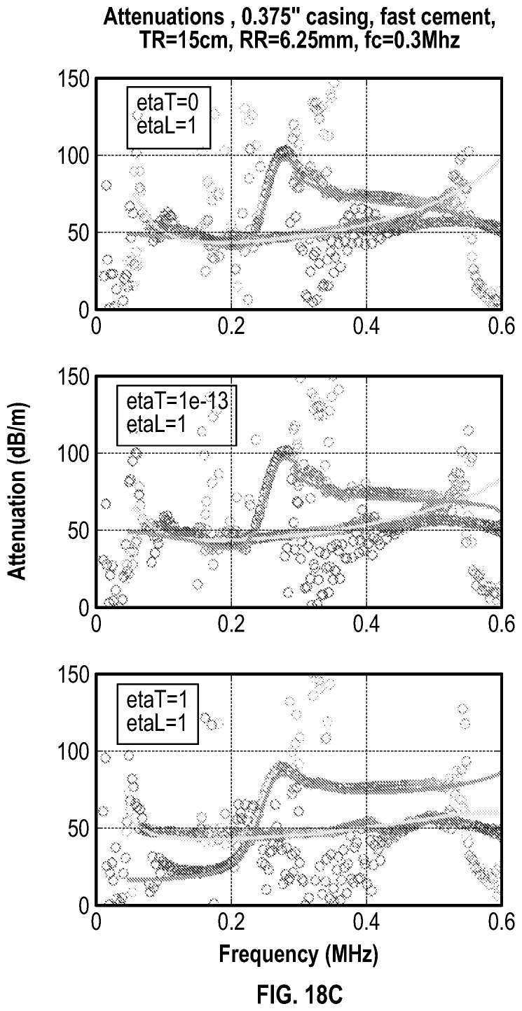

FIGS. 17 and 18 show plots of estimated attenuation dispersions from a well-known dispersion estimator using the matrix pencil approach, TKO, for various values of hN and hT, as applied to synthetic signals generated with a numerical simulator for the pitch-catch measurement.

In these FIGS., the solid lines referred to dispersions generated from a modal root-search approach which however is corrected to account for the additional attenuation associated with beam divergence along the direction parallel to the casing surface.

The good agreement between signal-based dispersions and mode-search approach and the TKO-estimated dispersions build confidence in the ability to invert for the intrinsic parameters of the annular fill and separately the compliance components. A generic workflow to implement an inversion approach is depicted in FIG. 3.

The method as described above may be accomplished through the use of a computing apparatus. A processor is provided to perform computational analysis for instructions provided. The instruction provided, code, may be written to achieve the desired goal and the processor may access the instructions. In other embodiments, the instructions may be provided directly to the processor. The code may be provided on self-contained apparatus, that are machine readable to allow the method instructions to be performed.

In other embodiments, other components may be substituted for generalized processors. These specifically designed components, known as application specific integrated circuits (“ASICs”) are specially designed to perform the desired task. As such, the ASIC's generally have a smaller footprint than generalized computer processors. The ASIC's, when used in embodiments of the disclosure, may use field programmable gate array technology, that allow a user to make variations in computing, as necessary. Thus, the methods described herein are not specifically held to a precise embodiment, rather alterations of the programming may be achieved through these configurations.

In embodiments, when equipped with a processor, the processor may have arithmetic logic unit (“ALU”), a floating point unit (“FPU”), registers and a single or multiple layer cache. The arithmetic logic unit may perform arithmetic functions as well as logic functions. The floating-point unit may be math coprocessor or numeric coprocessor to manipulate number for efficiently and quickly than other types of circuits. The registers are configured to store data that will be used by the processor during calculations and supply operands to the arithmetic unit and store the result of operations. The single or multiple layer caches are provided as a storehouse for data to help in calculation speed by preventing the processor from continually accessing random access memory (“RAM”).

Aspects of the disclosure provide for the use of a single processor. Other embodiments of the disclosure allow the use of more than a single processor. Such configurations may be called a multi-core processor where different functions are conducted by different processors to aid in calculation speed. In embodiments, when different processors are used, calculations may be performed simultaneously by different processors, a process known as parallel processing.

The processor may be located on a motherboard. The motherboard is a printed circuit board that incorporates the processor as well as other components helpful in processing, such as memory modules (“DIMMS”), random access memory, read only memory, non-volatile memory chips, a clock generator that keeps components in synchronization, as well as connectors for connecting other components to the motherboard. The motherboard may have different sizes according to the needs of the computer architect. To this end, the different sizes, known as form factors, may vary from sizes from a cellular telephone size to a desktop personal computer size. The motherboard may also provide other services to aid in functioning of the processor, such as cooling capacity. Cooling capacity may include a thermometer and a temperature-controlled fan that conveys cooling air over the motherboard to reduce temperature.

Data stored for execution by the processor may be stored in several locations, including the random access memory, read only memory, flash memory, computer hard disk drives, compact disks, floppy disks and solid state drives. For booting purposes, data may be stored in an integrated chip called an EEPROM, that is accessed during start-up of the processor. The data, known as a Basic Input/Output System (“BIOS”), contains, in some example embodiments, an operating system that controls both internal and peripheral components.

Different components may be added to the motherboard or may be connected to the motherboard to enhance processing. Examples of such connections of peripheral components may be video input/output sockets, storage configurations (such as hard disks, solid state disks, or access to cloud-based storage), printer communication ports, enhanced video processors, additional random-access memory and network cards.

The processor and motherboard may be provided in a discrete form factor, such as personal computer, cellular telephone, tablet, personal digital assistant or other component. The processor and motherboard may be connected to other such similar computing arrangement in networked form. Data may be exchanged between different sections of the network to enhance desired outputs. The network may be a public computing network or may be a secured network where only authorized users or devices may be allowed access.

As will be understood, method steps for completion may be stored in the random access memory, read only memory, flash memory, computer hard disk drives, compact disks, floppy disks and solid state drives.

Different input/output devices may be used in conjunction with the motherboard and processor. Input of data may be through a keyboard, voice, Universal Serial Bus (“USB”) device, mouse, pen, stylus, Firewire, video camera, light pen, joystick, trackball, scanner, bar code reader and touch screen. Output devices may include monitors, printers, headphones, plotters, televisions, speakers and projectors.

Different potential embodiments of the disclosure will now be described. In one example embodiment, a method for in-situ quantification of a bond between a casing and an annular fill is described. The method comprises sending ultrasonic signals to a desired location of a wellbore casing wherein the bond is to be determined. The method further comprises receiving reflected ultrasonic signals from the desired location. The method further comprises inverting the received reflected ultrasonic signals and processing the inverted received ultrasonic signals to produce at least one physical parameter of an annual fill at the interface location.

In another example embodiment, the method may be performed wherein the physical parameter is one of a compressional wave speed and a sheer wave speed.

In another example embodiment, the method may be performed wherein the physical parameter is one of an interfacial compliance.

In another example embodiment, the method may be performed wherein the processing accounts for discontinuities in attenuation dispersion.

In another example embodiment, the method may further comprise obtaining additional pulse echo data from the desired location; inverting the additional pulse echo data and processing the inverted pulse echo data to produce an interfacial compliance component.

In another example embodiment, the method may be performed wherein the processing calculates an acoustic equivalent liquid layer.

FORMATION-TO-CASING INTERFACIAL ACOUSTIC BOND AND RELATION TO HYDRAULIC PROPERTIES OF SUCH INTERFACE

In another example embodiment, the method may be performed wherein the processing of the additional pulse echo data and the inverted received ultrasonic signals occurs simultaneously.

In another example embodiment, the method may further comprise generating an image of data for the interface.

In another example embodiment, the method may further comprise generating a log of data for the interface.

In another example embodiment, the method may further comprise inputting at least one of casing parameters, mud parameters, hole geometry and tool parameters prior to processing the inverted received ultrasonic signals and wherein the processing of the inverted received ultrasonic signals includes and identifying discontinuities from a model-based matching.

In another example embodiment, the method may be performed wherein the identifying discontinuities occurs prior to the processing the inverted received ultrasonic signals to produce at least one physical parameter of an annual fill

In another example embodiment, the method may further comprise extracting one of a flexural signal and an extensional signal from the received ultrasonic signals.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for in-situ quantification of a bond between a casing and a surrounding annular fill, comprising:
sending ultrasonic signals to a desired location of a wellbore casing wherein the bond is to be determined;
receiving reflected ultrasonic signals from the desired location;
inverting the received reflected ultrasonic signals; and
processing the inverted received ultrasonic signals to produce at least one physical parameter of an annual fill at the interface location.

2. The method according to claim 1 wherein the physical parameter is one of a compressional wave speed and a sheer wave speed.

3. The method according to claim 1, wherein the physical parameter is one of an interfacial compliance.

4. The method according to claim 1, wherein the processing accounts for discontinuities in attenuation dispersion.

5. The method according to claim 1, further comprising:
obtaining additional pulse echo data from the desired location;
inverting the additional pulse echo data; and
processing the inverted pulse echo data to produce an interfacial compliance component.

6. The method according to claim 1, wherein the processing calculates an acoustic equivalent liquid layer.

7. The method according to claim 5, wherein the processing of the additional pulse echo data and the inverted received ultrasonic signals occurs simultaneously.

8. The method according to claim 1, further comprising:
generating an image of data for the interface.

9. The method according to claim 1, further comprising:
generating a log of data for the interface.

10. The method according to claim 1, further comprising:
inputting at least one of casing parameters, mud parameters, hole geometry and tool parameters prior to processing the inverted received ultrasonic signals and wherein the processing of the inverted received ultrasonic signals includes:
identifying discontinuities from a model-based matching.

11. The method according to claim 10, wherein the identifying discontinuities occurs prior to the processing the inverted received ultrasonic signals to produce at least one physical parameter of an annual fill

12. The method according to claim 1, further comprising:
extracting one of a flexural signal and an extensional signal from the received ultrasonic signals.
